(19) United States
(12) Patent Application Publication
(10) Pub. No.: US 2005/0138658 A1
(43) Pub. Date: Jun. 23, 2005

(54) Digital audio/video recorders with user specific predictive buffering

(76) Inventor: David Alan Bryan, Danbury, CT (US)

Correspondence Address: GOTTLIEB RACKMAN & REISMAN PC, 270 MADISON AVENUE, 8TH FLOOR, NEW YORK, NY, 100160601, US

(21) Appl. No.: 10/845,942

(22) Filed: May 14, 2004

Related U.S. Application Data
(63) Continuation-in-part of application No. 10/738,419, filed on Dec. 17, 2003.

(51) Int. Cl. H04N 7/025; H04H 9/00; H04N 5/445; G06F 3/00

(52) U.S. Cl. 725/46; 725/14; 725/9; 725/35

(57) ABSTRACT

A method and apparatus for predictive buffering in a media recorder, the method comprising the steps of predictively determining at least one program of interest to a user, and buffering a portion of the program. The program is selected using various criteria based on user profiles. User profiles are selected based on user behavior and direct information from the user.

### RELATED APPLICATIONS

This application is related to the following United States patent applications, incorporated by reference herein:
TELEVISION VIEWING COMMUNITIES, filed Dec. 24, 2003, Ser. No. 10/746,809; and
METHOD AND APPARATUS FOR EXCHANGING PREFERENCES FOR REPLAYING A PROGRAM ON AN PERSONAL VIDEO RECORDER filed Dec. 10, 2003, Ser. No.10/733,521.

This application is also a continuation in part of an application entitled PERSONAL VIDEO RECORDERS WITH AUTOMATED BUFFERING, Ser. No. 10/738,419 filed Dec. 17, 2003, also incorporated herein by reference.

### BACKGROUND OF THE INVENTION

1. Field of Invention

This invention pertains to a method and apparatus for buffering portions of a broadcast program. More specifically, the invention pertains to a method and apparatus that continuously monitors one or more program sources, determines whether any of the programs are of interest to a user and in response buffers a portion of the program to allow the user to view the program from the beginning. The buffering is controlled by profiles that are preferably generated dynamically using viewer habits.

2. Description of the Prior Art

Because of their flexibility, advanced capabilities, and ease-of-use, digital technology-based consumer products such as Personal Video Recorders (PVRs) have begun to provide an alternative to VCRs as the primary means for recording television programs in the home. PVRs have a number of technical advantages over VCRs and other analog recording technologies, stemming primarily, from the fact that they use digital data storage devices such as hard drives and optical discs. These types of data storage devices provide significantly more storage capacity because of high storage density and the use of digital compression techniques. They also provide fast and random access to their content and the ability to manage this content very easily. Finally, digital random access allows for the simultaneous reading and writing of two or more data streams.

PVRs typically use powerful microprocessors to control the digital storage and other functionality. These processors generally provide more processing power than the controllers used in VCRs and are capable of supporting sophisticated processing.

PVRs and similar devices allow consumers to spend more time watching television or video programming that they like, and less time sorting through or watching television or programming they don't like. With a PVR, a consumer can find a program or series of programs of interest from an on-screen program guide, and direct the system to record an individual program or all of the programs pertaining to particular subject matter, interests, or meeting some other criteria.

PVRs have many other advantages as well. A PVR can be programmed to skip reruns or adjust for broadcast schedule changes. For example, the TiVo “Season Pass” recording service allows a user to record a series during a whole season. A PVR user can also find and record television programs by title, sports team, actor, director and word.

Some PVRs also allow the user to rate programs, and, based on the programs the user indicates are of interest, will “learn” what types of programs the user likes and will record those types of programs (in their entirety) automatically. The user can subsequently locate the list of stored programs from a menu or catalog and retrieve an individual title for viewing. This allows the user to simply locate and view the recording and avoids the use of bulky storage tapes that need to be manually inserted and which take up significant storage space.

A feature that significantly differentiates a PVR from the traditional Video Cassette Recorder (VCR) is the PVR's ability to simultaneously record a program while playing back the same or different program. This feature allows a user to pause a current program (even if it is ‘live’), and then, some time later, continue watching the program from the instant that the program was paused while the remainder of the program is being recorded (if required). This mode of operation is termed ‘incidental recording’.

In current PVRs, incidental recording is simply implemented by recording whatever a user is currently watching as defined or determined by the setting of the PVR tuner and/or the tuner of the user's TV set. If the PVR is not set for incidental recording, it records only scheduled programs. Programs can be scheduled for recording either by the user's explicit instructions or by an automated program selector). While the user is watching a program previously recorded by the PVR, the PVR may also be recording whatever channel was last viewed. Thus, because current PVRs are active only during incidental recording or during scheduled programs, they cannot accommodate a user who wants to watch an unscheduled program in progress from the beginning. For example, if a user arrives home 5 or 10 minutes late, he/she is not able to watch an unscheduled program from the beginning by “rewinding ” the PVR since the PVR is not recording the program. Finally, users who channel surf during commercial breaks or “simultaneously” watch multiple sporting events usually do not have the ability to rewind an unscheduled program to a point before they switched channels.

### SUMMARY OF THE INVENTION

In co-pending U.S. application Ser. No. 10/738,419 filed Dec. 17, 2003, in one embodiment, a method is implemented on a PVR to automatically and intelligently buffer portions of programs, including television programs or other media streams, such as radio broadcasts. The buffering of programs is implemented using predictive selections based on the viewing habits and preferences of a PVR user, recommendation from friends and critics, etc.

Predictive buffering is an entirely automated process (requiring no user direction or input) and learns directly from the user and external sources without any need for reference to a centralized database. The predictive buffer records programs (or program portions or fragments) based on its internal logic, user behavior, and external recommendations.

The invention can be implemented in both stand-alone home-use PVRs as well as centralized (head-end) PVRs or local PVRs with distributed or network storage.

According to this invention, one or more program sources are monitored and if a program is detected that may be of interest to a user, a portion of the program is buffered for a predetermined period of time, thereby allowing the user to watch the program from the beginning. Importantly, programs are selected based on profiles associated with specific users. The profiles are selected based on information inferred from monitoring user behavior and on information provided directly by the user.

In one embodiment, a new user's behavior is monitored and various characteristics of the user are used to generate a new profile. A user can identify himself directly, or he is recognized based on his present and past behavior.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates a typical hookup of a Personal Video Recorder into a home entertainment system;

FIG. 2 is a simplified functional block diagram of a Personal Video Recorder;

FIG. 3 is a simplified functional block diagram of an alternate embodiment of a Personal Video Recorder;

FIG. 4a shows an embodiment of Personal Video Recorder where a plurality of channels may be recorded simultaneously;

FIG. 4b shows an alternate embodiment of Personal Video Recorder where a plurality of channels may be recorded simultaneously;

FIG. 5a and FIG. 5b illustrate one possible data structure to track weekly user viewing habits;

FIG. 6 illustrates a flow chart for an exemplary process used to populate the table of weekly timeslots;

FIG. 7 illustrates a flow chart for an exemplary process to use the table of weekly timeslots to perform the predictive buffering function;

FIG. 8 illustrates a flow chart of a method of selecting a profile in accordance with the present invention; and

FIG. 9 shows a system with several PVRs controlled by a PC.

### DETAILED DESCRIPTION OF SPECIFIC EMBODIMENTS OF THE INVENTION

In describing the embodiments of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose. For example, when we use the term “PVR”, we are generally referring to a consumer device with digital storage that is capable of recording television and other multimedia programs, including standard AM, or FM radio programs broadcast over RF channels, as well as radio broadcasts from satellites and “Internet radio” broadcasts. While this includes devices like those sold today by TiVo Inc. and ReplayTV (Digital Networks North America, Inc.), it is also intended to include any stand-alone device with similar functionality, as well as set-top boxes for cable and satellite television that have the same or similar recording capability. Also contemplated in this discussion are personal computers with a television tuner and software that allows the personal computer to operate as a PVR.

Additionally, when we refer to a “channel”, we are including not only the traditional notion of a local broadcast network affiliate or station, but also the digital equivalent and any other distinctly identifiable (numbered, lettered, labeled, etc.) media vehicle, whether over-the-air, on a cable or satellite delivery system, or through any other private or public network (including the Internet). Likewise, when we refer to a “program” or a “show”, we include both the conventional concept of a complete ½ hour to 2 hour television presentation as well as any complete or partial segment of a regular or special broadcast event.

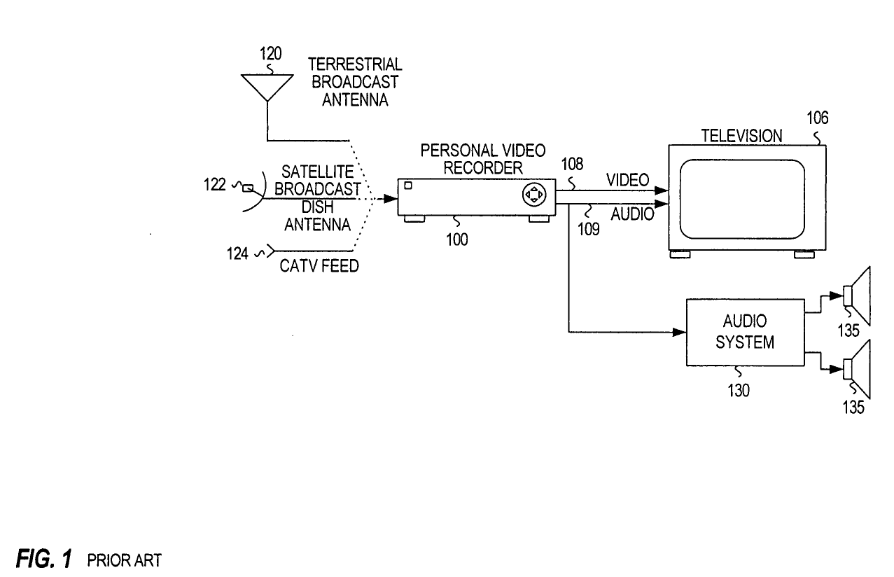

FIG. 1 illustrates a typical hookup of a Personal Video Recorder into a home entertainment system. In the system illustrated, Personal Video Recorder 100 is connected to one or more program sources. The program sources may include terrestrial broadcast, satellite broadcast, and cable television (CATV). These program sources are received respectively by a Terrestrial Broadcast Antenna 120, a Satellite Broadcast Dish Antenna 122, and a CATV Feed 124. A program source may comprise analog, digital or a combination of analog and digital types of programs. Video Output 108 and Audio Output 109 of Personal Video Recorder 100 are connected to Television 106 for presentation to the user of programs from Personal Video Recorder 100. Audio Output 109 may alternatively or additionally be connected to Audio System 130 for high-fidelity playback on speakers 135. For radio programs, the video signals are omitted.

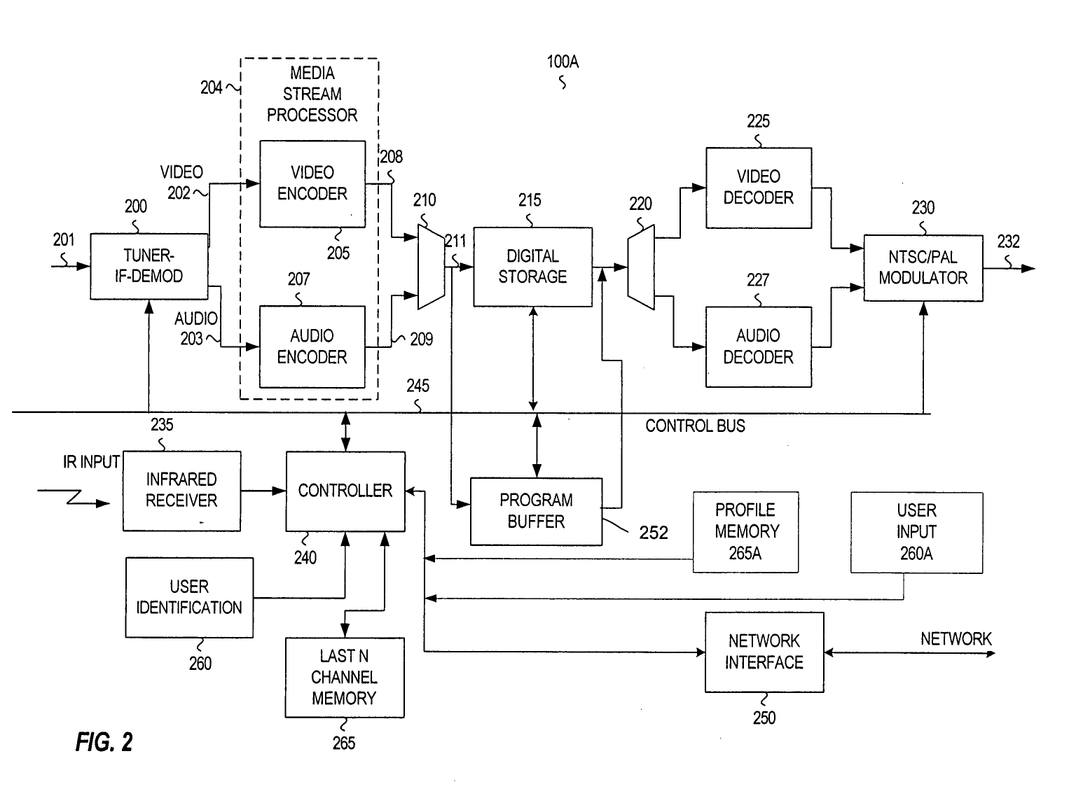

FIG. 2 is a simplified functional block diagram of Personal Video Recorder 100A constructed in accordance with this invention. The particular PVR illustrated in FIG. 2 is for use with analog television broadcasts (over-the-air or CATV, for example). The antenna/cable feed 201 is input to Tuner-IF-Demod 200. Tuner-IF-Demod 200 is the combined functionality of tuner, intermediate frequency (IF) processing, and demodulator. (When we refer, in this specification, to a “tuner”, we are typically referring to the Tuner-IF-Demod combination.) These functions serve to tune the selected channel, filter and mix the selected channel to baseband, and demodulate the received signal into video signal 202 and audio signal 203. The channel is selected by the user through an IR (infrared) remote control (not shown) through Infrared Receiver 235 and Controller 240. Controller 240 programs the channel in Tuner-IF-Demod 200 through Control Bus 245.

Video signal 202 and audio signal 203 are processed by Media Stream Processor 204, which includes Video Encoder 205 and Audio Encoder 207. Video Encoder 205 digitizes (converts from analog form into digital form) and compresses video signal 202. Video Encoder 205 may use one of the many video compression algorithms such as those included in the standards commonly known as MPEG-1, MPEG-2, or MPEG-4, or another algorithm. Audio Encoder 207 digitizes and compresses audio signal 203. Audio Encoder 207 may use one of the many audio compression algorithms such as those included in the standards commonly known as MPEG-1 (including the algorithm commonly called MP3), MPEG-2, or MPEG-4, or another algorithm. Video Encoder 205 and Audio Encoder 207 may also encrypt the media steams to protect them from unauthorized copying. The digitized video and audio signals 208 and 209 are multiplexed in multiplexer 210 and the multiplexed signal 211 is stored in a file on Digital Storage 215 under the control of Controller 240 through Control Bus 245. Digital Storage 215 may be any fixed or removable mass storage device, including a hard disk drive, an optical disk drive, flash memory, etc.

Playback comprises the retrieval of a desired media file from Digital Storage 215, and demultiplexing the retrieved media in demultiplexer 220. The demultiplexed video and audio streams are decoded by Video Decoder 225 and Audio Decoder 227. Video Decoder 225 and Audio Decoder 227 use the appropriate decompression algorithms based on those used in Video Encoder 205 and Audio Encoder 207. Video Decoder 225 and Audio Decoder 227 may also decrypt the media streams if they were encrypted during the encoding process. The outputs of Video Decoder 225 and Audio Decoder 227 are converted to a form that is appropriate for display on Television 106 by NTSC/PAL Modulator 230. The output signals 232 of NTSC/PAL Modulator 230 may include an RF modulated composite video and audio signal as well as separate video and audio signals. Separate video signals may include a baseband composite video signal, an S-Video signal, and a component video signal. Audio signals may include line level analog mono or stereo audio and S/PDIF digital audio signals.

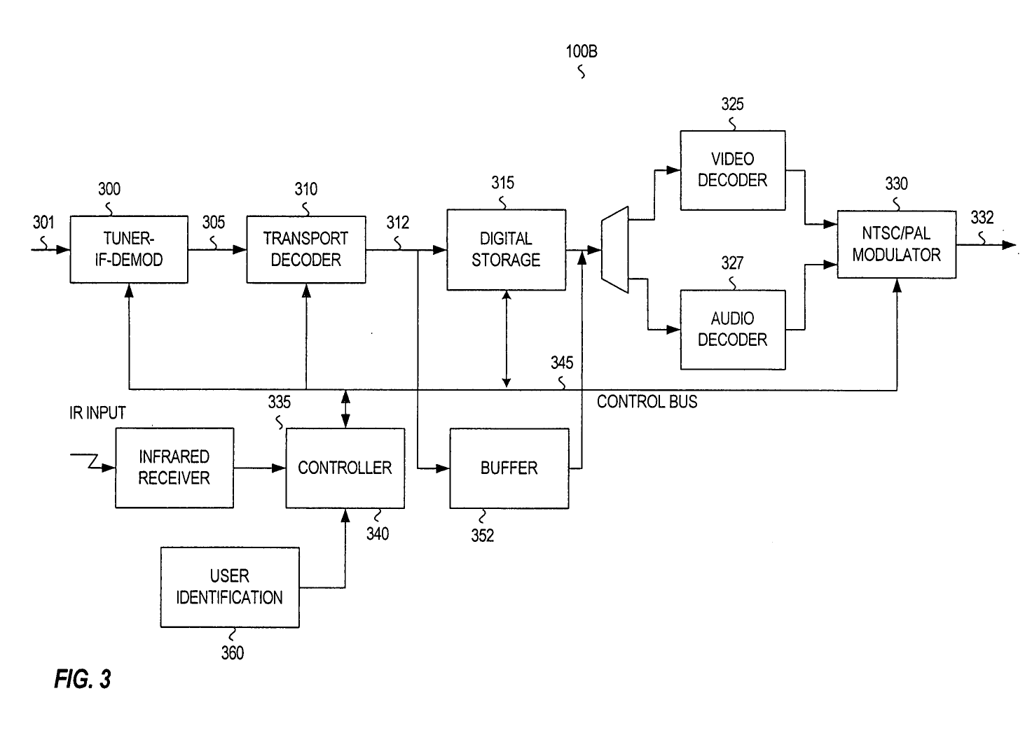

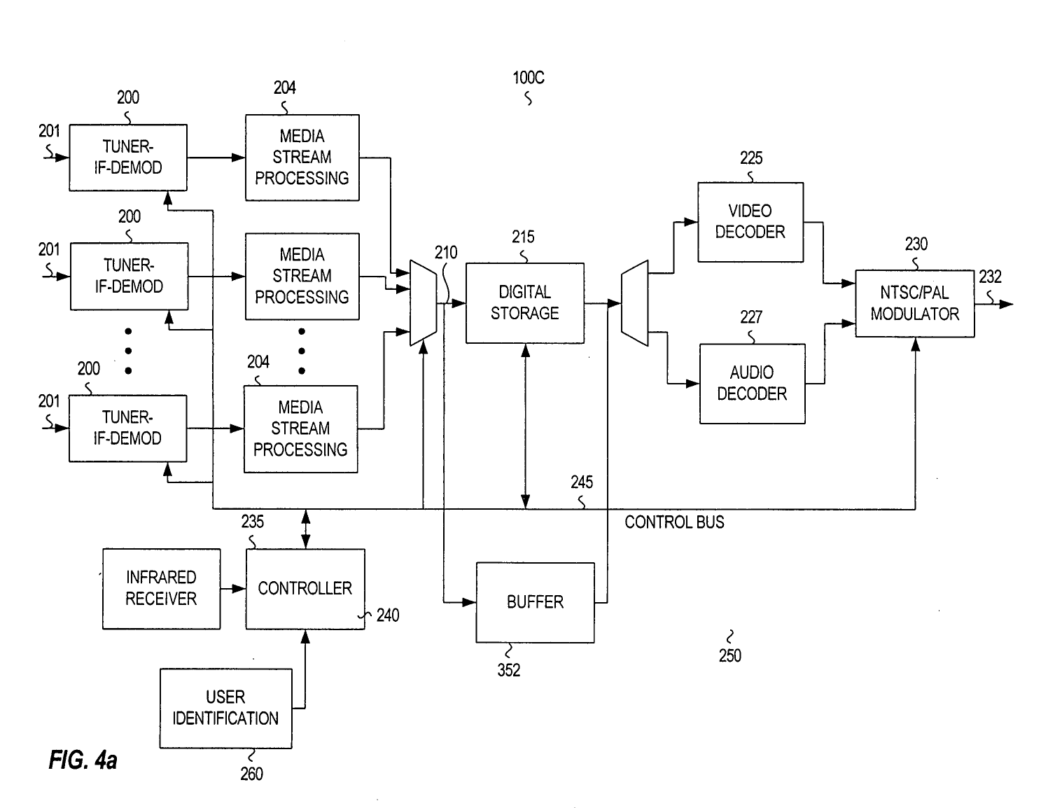

Controller 240 is responsible for managing all of the functions of Personal Video Recorder 100A and is also responsible for managing the files on Digital Storage 215. Included in the management of the files on Digital Storage 215 is the monitoring of free storage space, removal of unused or unneeded files, and prioritization of storage operations. Controller 240 is also responsible for acquiring, formatting and displaying an Electronic Program Guide (EPG) on television 106. Controller 240 may acquire the data required for the EPG from information carried on the broadcast signal or by downloading data through Network Interface 250 ( In FIGS. 3, 4a, 4b, this Network Interface 250 has been omitted for the sake of clarity). The EPG displays a listing of current and upcoming programs on all of the available channels. The user navigates the EPG, searches for programs, and selects programs to view or record by using an IR remote control (not shown) through Infrared Receiver 235.

Referring again to FIG. 2, Digital Storage 215 has a read/write bandwidth that is sufficient, at a minimum, to effectively support simultaneous read and write operations. This allows a user, for example, to watch a previously recorded program while another program is being recorded. It is also known in the art to play back the same show that is currently being recorded. In many current PVRs, when the user is watching a “live” (or current) program through the PVR, he/she is actually watching playback from the storage media delayed by only a fraction of a second as the program is being recorded. In this way, the PVR can facilitate the “pausing” of a live television broadcast. When the user presses the “Pause” button on the remote control, the PVR freezes the playback display but continues to record the program or channel that the user was watching. When the user wishes to continue watching from the pause point, the PVR begins playback of the recorded program from this point while continuing to record the program or channel. The ability to pause live TV is enabled by the incidental (not explicitly instructed) recording of whatever channel the user is currently viewing. This recording is typically stored in a section of Digital Storage 215 set aside (either statically or dynamically) for this incidental recording.

Playback from Digital Storage 215 may also be prompted by a request from the user. The user makes a playback request through an on-screen catalog of recorded programs.

Referring again to FIG. 2, User Identification 260 is used, in some embodiments, to identify which user (or users), from a household of users, is (or are) currently watching programs through the PVR. As discussed in more detail below, User Identification 260 is useful in determining the individual preferences of the user watching TV at a particular moment, if more than one individual is using the same TV, and to determine which programs to buffer.

Those skilled in the art will appreciate that many of the functions illustrated as separate functional blocks in the diagram illustrated in FIG. 2 (as well as the block diagrams illustrated in FIGS. 3, 4A, and 4B) may be implemented using one or more standard or custom integrated circuit devices, or incorporated wholly, or in part, into controller 240 or into another microprocessor, media processor, digital signal processor, or the like. The block diagrams are intended only to illustrate a functional model of the described embodiment for the purpose of clearly describing these embodiments, and are not intended to illustrate the only possible implementation of these embodiments.

FIG. 3 is a simplified functional block diagram of an alternate embodiment of Personal Video Recorder 100B. The PVR embodiment illustrated in FIG. 3 is for use with digital broadcasts (over-the-air, CATV, or satellite, for example). The antenna, cable, or satellite dish feed 301 is input to Tuner-IF-Demod 300. Tuner-IF-Demod 300 is the combined functionality of tuner, intermediate frequency (IF) processing, and demodulator. These functions serve to tune the selected channel, filter, mix and demodulate the selected channel to baseband—forming digital transport stream 305. As in FIG. 2, the channel is selected by the user through an IR (infrared) remote control (not shown) through Infrared Receiver 335 and Controller 340. Controller 340 programs the channel in Tuner-IF-Demod 300 through Control Bus 345.

Digital transport stream 305 may include the data streams from a single program or may include streams from multiple programs. A specific program stream 312 is selected from digital transport stream 305 by Transport Decoder 310. Transport Decoder 310 selects the appropriate program stream based on information provided by Controller 340 over Control Bus 345. Program stream 312 typically consists of at least one media type, but more typically would comprise at least one compressed digital video and one compressed digital audio stream. Program stream 312 is stored in Digital Storage 315 under the control of Controller 340 through Control Bus 345.

Playback of recorded media in FIG. 3 is identical to the playback process described above referring to FIG. 2, except that Video Decoder 325 and Audio Decoder 327 use algorithms that are appropriate for decoding the digital broadcast streams from the over-the-air, CATV, or satellite system. User Identification 360 is used, in some embodiments, to identify which user (or users), from a household of users, is (or are) currently watching programs through the PVR, as discussed in more detail below.

Most television receivers and VCRs come equipped with only a single tuner. This tuner is used by a television to tune to the user-selected channel. In a VCR, the tuner is used to tune to the channel to be recorded, or the channel that is being viewed if the user is watching television “through” the VCR. In some modern television receivers, a second tuner is included to tune an alternate channel and display this channel on a small inset picture on the television display. This feature is called Picture-in-Picture (also called “Pix-in-Pix” or simply “PIP”). VCRs have traditionally included only a single tuner, since they have the capacity to record only one program at a time.

Most PVRs made today also only include only a single tuner, as illustrated in FIG. 2 and FIG. 3, since they usually have the processing power to encode (digitize and compress) a single video and audio signal for recording on the digital storage media. Some PVRs, however, come equipped with two tuners, along with the capacity to record two programs simultaneously.

FIG. 4a shows another embodiment of Personal Video Recorder 100C. This embodiment is similar to that shown in FIG. 2, except that in this embodiment a plurality of channels may be recorded simultaneously. FIG. 4a shows, as an example, three instances of Tuner-IF-Demod 200 and Media Stream Processor 204, which would allow for three simultaneous channels to be recorded. Any number of instances of Tuner-IF-Demod 200 and Media Stream Processor 204 may be implemented, limited primarily by the bandwidth of Digital Storage 215.

FIG. 4b shows yet another embodiment of a Personal Video Recorder. This embodiment is similar to that shown in FIG. 3 and FIG. 4a, except that in this embodiment Personal Video Recorder 100D may simultaneously record a plurality of channels from a digital broadcast source. Like FIG. 4a, FIG. 4b shows multiple instances of Tuner-IF-Demod 300. Unlike the analog system of FIG. 4a, the digital system of FIG. 4b typically contains multiple programs streams within each demodulated output stream 305. There may be one or more instances of Tuner-IF-Demod 300 (three are shown in FIG. 4b) and one or more Transport Decoders 310 for each instance of Tuner-IF-Demod 300. In FIG. 4b, two Transport Decoders (310a and 310b) are shown connected to Tuner-IF-Demod 300a, one Transport Decoder 310c is connected to Tuner-IF-Demod 300b, and one Transport Decoder 310d is connected to Tuner-IF-Demod 300c. This exemplary combination would allow for up to four simultaneous programs to be recorded. Any number of instances of Tuner-IF-Demod 300 and Transport Decoder 310 (with at least one Transport Decoder 310 per Tuner-IF-Demod 300 required) may be implemented, limited primarily by the bandwidth of Digital Storage 315.

In prior art PVRs, if the user was not watching a current broadcast through the PVR (when the PVR was “Off”), only programs that had been scheduled for recording were typically recorded. If the user was watching a program previously recorded by the PVR, the PVR may also have been recording whatever channel was last being viewed live. In this sense, prior art recording only addressed the ability to pause a live broadcast.

In the present invention, an idle PVR enters a buffering mode in which the PVR determines if a program available from a single source (for the embodiments of FIGS. 2 and 3) or multiple sources (for the embodiments of FIGS. 4a and 4b) are of interest to one or more users. If such a program is detected, then a portion of the program is buffered.

More specifically, referring to FIG. 2, while the PVR 100A is idle, the controller 240 monitors the programs available to tuner 200. If a program is identified that is likely to be of interest to the user, then the multiplexed signal 211 is stored in Buffer 252. Buffer 252 is large enough so that it can store a predetermined portion of the program, for example the first 15-30 minutes. (Buffer 252 is shown as a separate element, although it could be implemented as part of storage 215.)

Predictive buffering pertains to a process of recording one or more programs or program fragments in anticipation of a viewer being interested in watching a program on a PVR or switching PVR channels. One objective of predictive buffering is to allow a user to begin watching a program from the beginning, despite switching on the television sometime after the start of the program. A second objective of predictive buffering is to allow a user to channel surf or watch several programs “simultaneously” with the ability to rewind to portions missed while watching another channel or program.

In one embodiment, predictive buffering comprises the steps of:
observing, learning or discovering user habits, schedules and other patterns of viewership,
processing this data to determine television programs that have an elevated likelihood of being watched by the viewer, and
automatically buffering these programs in anticipation of a user wanting to watch them.

The extent to which predictive buffers may be used is a function of the capabilities of a PVR or PVR-like device. Since predictive buffers use idle PVR record capacity, predictive buffering capability is a function of the number of tuners (and transport decoders in PVRs for digital broadcast), the media stream processing capacity, and the read/write bandwidth of the digital storage device. As discussed above, in a PVR that has only a single tuner (FIG. 2 or FIG. 3, for example), predictive buffering can only be done on a single channel in either buffer 252 or 352 and only while the user is not watching television through the PVR and the PVR is not making a prescheduled recording. Note that if the user is watching a previously recorded program from the PVR and the PVR is not recording a prescheduled program, the tuner is available for use by the predictive buffering process.

Additional tuners and transport decoders within a PVR (see FIG. 4a and FIG. 4b) enhance the capability to perform predictive buffering by providing more opportunities to make use of otherwise idle recording capacity. It also enhances the predictive buffering capability by allowing for the simultaneous buffering of several programs on multiple channels. Predictive buffering of multiple channels simultaneously would be useful, for example, with sports fans who channel surf between or among multiple sporting events. Predictive buffering would track channel change activity and buffer, in addition to the channel being watched, the alternate channel or channels (depending on the capability of the PVR). In this way, the sports enthusiast would be able to rewind back to a missed goal or touchdown, even though they were not watching the channel at the time of the missed event. The controller either automatically determines which channels are being watched “simultaneously” or requests that the user enter a list of channels to be buffered.

In another embodiment, a variant on the above predictive buffering strategy is employed. In this embodiment, the last N channels watched are buffered, where N is the number of tuners (and transport decoders in PVRs for digital broadcast) available to the buffering process. The strategy of buffering the last N channels is based on the notion that a user is likely to continue watching a channel (or one of the channels) that they have been watching in the past few minutes. Last N Channel Memory 265 (illustrated in FIG. 2) provides a list of channels recently viewed by the user. This memory function may also be implemented inside controller 240. The same functionality is implemented (though not shown) in the embodiments illustrated in FIGS. 3, 4a, and 4b.

In yet another embodiment, a predictive buffering process tracks the daily and/or weekly viewing habits of the user and buffers channels and programs based on an estimate of what will be watched based on observed daily and/or weekly patterns. The predictive buffering process may also observe the particular programs that a user has watched in the recent past (days, weeks, or months) and buffers each occurrence of this program, regardless of timeslot. In another embodiment, a predictive buffering process tracks favorite genres of the user and buffers based on a best match of recording opportunities to these favorite genres. In yet another embodiment, a predictive buffering process uses information and recommendations gathered from on-line or off-line television critics, favorite Web Logs (blogs), buddy lists, chat rooms, and other on-line recommendations, and buffers programs and channels based on a best match between a profile of the PVR user and the on-line recommendations.

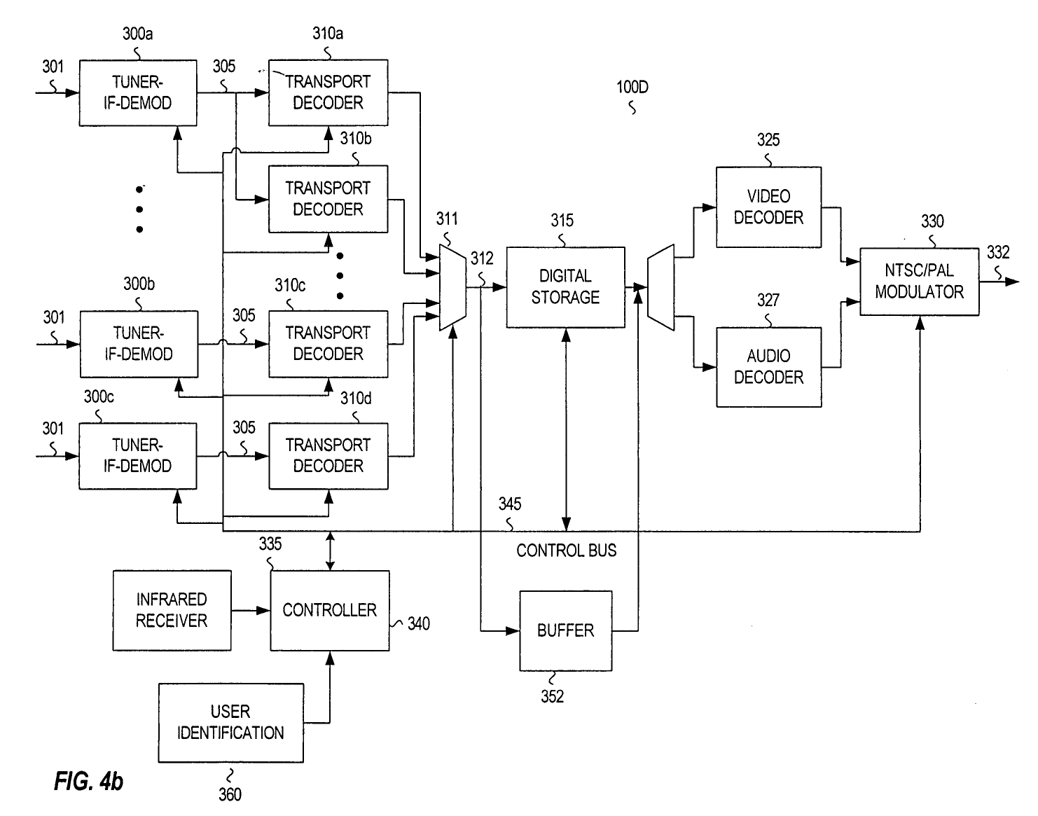

FIG. 5a and FIG. 5b illustrate one possible data structure to track weekly user viewing habits. Referring to FIG. 5a, table of weekly timeslots 500 is created as an initialization step. Table of weekly timeslots 500 comprises a plurality of columns, each of which represents one day of the week, and a plurality of rows, each of which represents a timeslot within a day. The duration of each timeslot may be set to any value, but is preferentially set to the duration of the shortest typical program (½ hour, in the example presented in FIG. 5a). A particular entry in the table is shown in the example as 520. This is the Monday 20:00 (8:00 PM) timeslot. The data structure for a typical timeslot 520 is expanded in FIG. 5b. Referring to FIG. 5b, timeslot 520 comprises zero or more entries as illustrated. Each entry in timeslot 520 contains a channel number 525 and a count 530. Count 530 indicates how many times the indicated channel has been watched. When timeslot 520 contains zero entries, this indicates that nothing was watched during the particular time slot (the PVR was always off during the time period indicated).

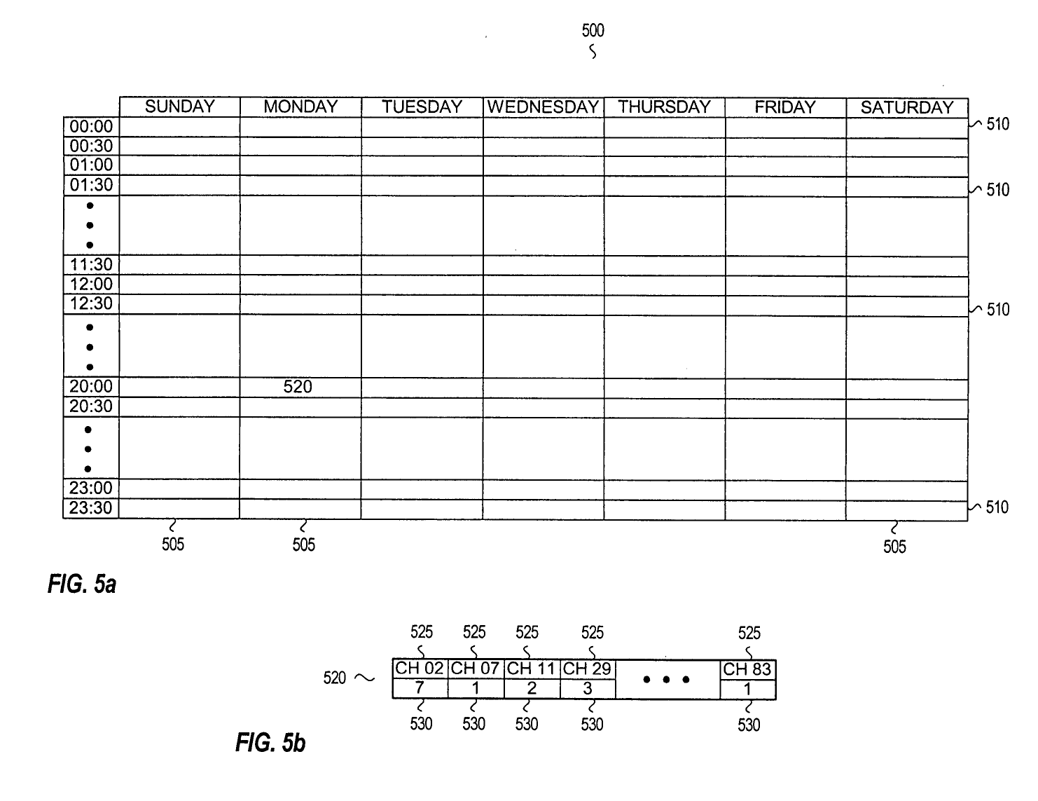

FIG. 6 illustrates a flow chart for an exemplary process used to populate table of weekly timeslots 500. Step 610 is the initialization step for the creation of the table. This step is performed when the PVR is first installed and powered. Once table of weekly timeslots 500 is created, the process runs continuously while the PVR is “On” (being used to watch television programs). The process monitors the current time and, when the current time indicates the start of a new timeslot (step 620), the current channel is retrieved (step 630). If the current channel is not yet in the current timeslot data structure (step 640), it is added (step 650). Otherwise, the count for the current channel in the current timeslot is incremented (step 660). In an alternate embodiment, instead of using the channel tuned to at the instant the timeslot begins, the channel watched for a majority of the time during the timeslot is used. In yet another embodiment, instead of a simple count of the number of times a channel was watched during a timeslot, the number of minutes watched for each channel within a timeslot is recorded.

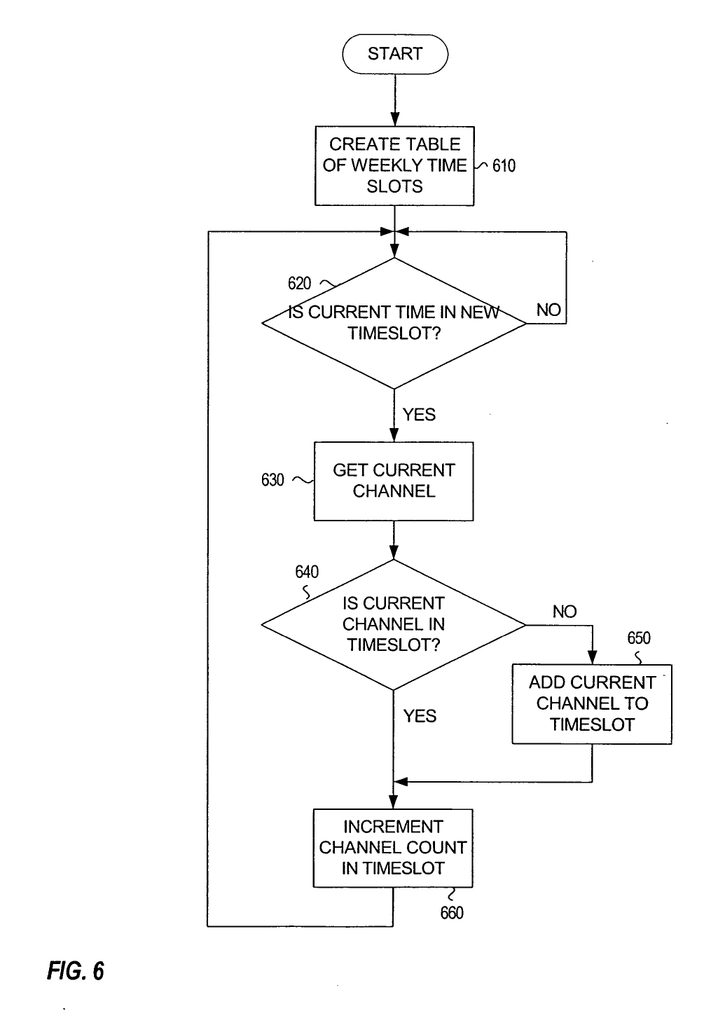

FIG. 7 is a flow chart for an exemplary process to use the table of weekly timeslots 500 to perform the predictive buffering function. The process begins by waiting for an available tuner (step 705). When a tuner becomes available, the process gets the entry in the table of weekly timeslots 500 that applies to the current day and time (step 710). If there are no channels listed in this entry (step 715), no action is taken. If one or more channel entries are present, the channel entry with the highest count is selected (step 720). The tuner is set to the channel indicated (step 725), and the unit begins recording (step 730) the respective stream in buffer 252. During the predictive buffering process, if the user turns on the unit or changes channel, the predictive buffering process goes back to an idle state (waiting for an available tuner).

Once predictive buffering begins, the process in FIG. 7 waits for the start of the next timeslot (step 735). At the start of the next timeslot, if a tuner is still available (step 740), the process checks for channel entries in the table of weekly timeslots 500 at the new timeslot (step 755). If an entry is present, the channel entry with the highest count is selected (step 720), the tuner is set to the channel indicated (step 725), and the unit begins recording (step 730) the new channel. If no channel entry is present, the unit may continue recording the channel from the previous timeslot (step 760) or may stop the recording process. Note that a PVR with multiple tuners may have multiple simultaneous processes like that shown in FIG. 7.

In another embodiment, genres of programs watched are tallied for each timeslot. Genres include, for example, Sports, News, Movies, Situation Comedy, Drama, Variety, Children's Programming, etc. The most common genre for programs watched in each timeslot may be used in addition to, or in place of, the channel frequency data described above. For example, at the start of each timeslot, assuming that a tuner is available, the most watched genre for the timeslot is compared to the genres of all programs available for buffering. The program whose genre is identical to, or closest to, the most watched genre for the timeslot is buffered.

In yet another embodiment, a list of most-watched programs (regardless of timeslot) is kept by the PVR. In each timeslot, programs available for buffering are compared to the list of most-watched programs. If any programs on the list match any of the programs available for buffering, the program highest on the list that is also available is buffered.

In yet another embodiment, the PVR is connected to the Internet or to a personal computer that is connected to the Internet. Program or channel recommendations are collected by the PVR from a variety of sources. These recommendations, either alone, or in combination with other techniques mentioned herein, would be used by the PVR to make decisions on which programs or channels to buffer. One source of recommendations is from on-line television critics. One or more selected on-line television critics' recommendations may be extracted from web-sites of reviews or may be delivered directly to the PVR or personal computer using a protocol such as RSS (Rich Site Summary) or other XML or text-based protocol. Another source of recommendations is a Web Log (commonly called a “blog”). The PVR would be configured to extract program or channel recommendations from specific Web Logs. Yet another source of recommendations is an instant messaging system (and related systems such as chat rooms, IRC, etc.). Program and channel recommendations would be extracted from instant messages and chat room conversations.

In one embodiment, when a user begins to watch a program that has been buffered in buffer 252 (or 352), after the start of the program, he/she has the option to rewind to the start of the program and watch it in its entirety. In another embodiment, when the user begins to watch a program that has been buffered by the PVR, after the start of the program, the PVR detects that the user has not seen the program from the beginning and automatically rewinds to the start of the program.

Program Buffer 242 (or 352), in one embodiment, can buffer only a limited quantity of program material. This limitation may be based on the available storage space at any particular time, or it may be a fixed and reserved amount of storage space. In either case, there is a need to flush unneeded program material from Program Buffer 242 (or 352) to allow for newer material to be buffered. When a program or a portion of a program is buffered, and the user does not indicate that he/she wants to watch the buffered program (or does not begin watching the program within some predetermined time from the start of the program), the buffered program or program portion is discarded to allow for a portion of another program to be buffered.

In most cases, the predictive buffering algorithms described above will work quite effectively, even in households with multiple viewers having different viewing preferences. This is based on the observation that the typical household television is used in a repeated and predictable manner, and that the programs viewed in each timeslot are likewise predictable. In some situations, this may not provide sufficient prediction accuracy. In one embodiment, the PVR includes the capability to detect which viewer within a household is watching in each time slot (for example, User Identification 260), and builds preference tables for each detected viewer. Detecting who is watching may be accomplished by using one or more of following strategies:
Associating a user with what channel is being watched.
Inferring from how the remote control is used in response to changes in the program being watched (for example, how much channel surfing does the user do, how quickly does a user switch away from commercials and how does the user set and modify the volume control and mute control).
Creating a dexterity profile by measuring generic parameters during the use of the remote control, including: timing, pressure, and duration of button presses (create unique viewer signatures).
Requesting or requiring that each user log in when he/she begins watching programs from the PVR. The PVR would be provided with a list of users during the set-up and initialization process. If a new user logs in, this user would be added to the user list.
Using one or more biometric recognition/identification technologies (fingerprint, iris, palm, voice, or face, for example) to identify the user or users currently watching.
Using a unique wireless tag contained within or attached to the body, clothing, or jewelry of, or embedded within any device (cell phone or PDA, for example), associated with (for example, carried by), each of the users. The tag may be implemented as a proprietary or industry standard Radio Frequency Identification (RFID) tag, an infrared identifier, an ultrasonic identifier, or any other equivalent means that provides wireless identification.

Once the viewing habits of several users are determined, for example, by using one or more of the criteria outlined above, viewing profiles may be derived that may be used to control buffering. These profiles are stored in a profile memory 265A shown in FIG. 2.

Alternatively, profiles may be derived by asking each of the users to respond to a questionnaire and then using the answers to develop rules of what certain users may or may not like. The answers from the users are collected from a user input 260A also shown in FIG. 2. A discussion of how various tastes of viewers is related to their habits is found in U.S. patent application Publication US 2003/0014407A1 published Jan. 16, 2003 and incorporated herein by reference.

Alternatively, several standard user profiles may be preselected and loaded into memory 265A either by the manufacturer or distributor of the apparatus, or by an operator. The operator may obtain the user profiles through network interface 250.

Thus, there are three ways in which profiles are stored in a PVR. First, a user responds to a list of questions related to his preferences. As discussed in Publication US 2003/0014407A1, the preferences may be inferred not only from a user's likes and dislikes of certain types of entertainment genre (e.g., likes Sherlock Holmes, dislikes Harry Potter), but from other criteria as well, such as the types of clothes a user likes to wear. Second, the preferences may be inferred from his viewing habits. Third, preselected profiles based on standardized user preferences may be preloaded into a PVR, and if necessary, modified.

A problem with the all these ways of profile generation is that since the preferences are inferred rather than being specifically selected, the selected profile could be wrong. Additionally, the first two ways are tedious and time consuming.

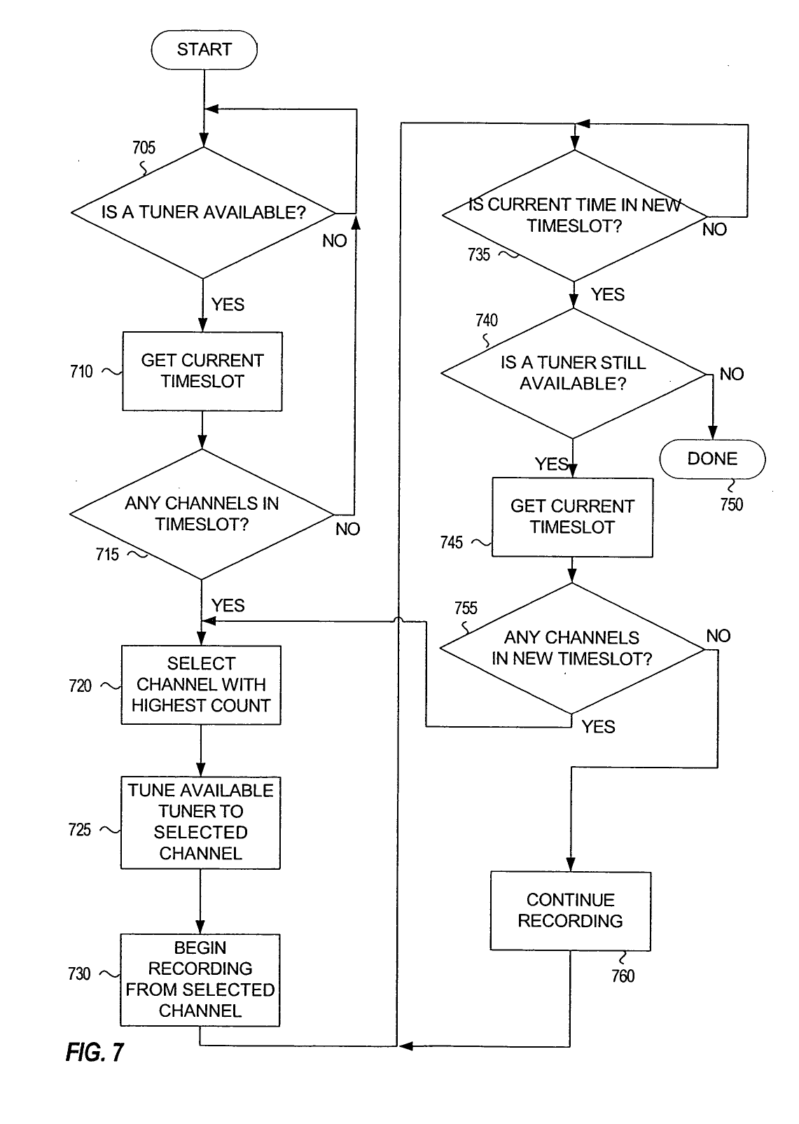

In the present invention, a novel method of generating a profile for a user is provided which has some elements of the three ways previously discussed. Referring to FIG. 8, in step 800 the step of generating a profile is initiated when an unknown users starts viewing a TV set. Each user is encouraged, through such means as on-screen prompts, and audible requests, and/or other means to identify himself or herself to the system, or, “register.”

In step 802 a determination is made as to whether a user has been identified, either from information provided by the user or from an electronic tag. The electronic tag could be a unique wireless tag contained within or attached to the body, clothing, or jewelry of, or embedded within any device (cell phone or PDA, for example), associated with (for example, carried by), each of the users. If the user is identified then in step 804 the profile assigned to the user is retrieved. In step 806 a determination is made as to whether the profile is valid or not. For example, in previous sessions, the user may not have provided sufficient information for the generation of the profile. If the profile associated with the user is valid, or satisfactory, then in step 808 the profile is used to provide the user with suggestions of what to watch, as discussed above. Otherwise, the user's actions are monitored, as discussed below in order to complete or fine tune the profile collected.

If in step 802 no direct identification is received from the user, the system can attempt to identify the user indirectly from some of the existing profiles. For this purpose, the system constructs a set of candidate user profiles by storing such data as: channel surfing frequency; channel change time after commercial startup; (re)settings of TV controls such as volume/mute; use of the remote control, including: timing, pressure, and duration of button presses; fingerprint, iris, palm, voice, or face data;; observing the particular programs that a candidate user has watched in the recent past (days, weeks, or months, genres of programs watched are tallied). Genres include, for example, Sports, News, Movies, Situation Comedy, Drama, Variety, Children's Programming, etc. The most common genre for programs watched may be used in addition to, or in place of, the channel frequency (e.g., “channel 6”) data.

In step 808, the system observes user behavior, and attempts to identify the user, and associates certain characteristics, (for example, channel surfing frequency), with that user. The latter characteristics are also useful to characterize the user for better deciding which programs should be buffered at a given time. This monitoring process continues (step 810) in accordance with a predetermined criteria. For example, the system may monitor user behavior for a predetermined time period. Alternatively, the system monitors the user's behavior and determines that the characteristics associated with the user do not appear to change substantially over time. If so, it can generate a request (step 812) for that user to explicitly enter certain profile information such as age, sex, race, etc. For example, such a request can be displayed on the TV screen, or it can be presented via the TV sound system. The user can also be asked to verify any inferred characteristics attributed to him/her, for example, “do you like to watch Westerns?” The user can be given the opportunity to confirm/deny these characteristics. Based on this, the system concludes that its inferred user profile contains internal inconsistencies, e.g, from its observations it thinks that this user likes Westerns, but this user denies liking Westerns. The system can then decide to base its profile for this user only on any explicit answers that the user is willing to provide, keep some (perhaps less speculative) inferred user data like keystroke patterns in its profile for that user, or erase its profile for that user altogether, in the last case, under the assumption that that user is a person who does not want to be “labeled” as having any particular preferences. The particular action taken by the PVR upon learning of inconsistencies may be “hard-wired” into it, or made programmable during initial setup and/or as a menu option during later operation. Alternatively, the action taken can be specified as part of explicit profile information provided by each user.

In case the user does not respond to requests to verify any inferred characteristics about her(him)self, the system can either revert to simply inferring which is the current user, and not ask the user to verify any of his inferred characteristics, or erase its inferred profile for that user. Preferably, the user should be presented with a choice as to which of these two PVR behaviors should take place, i.e., ask the user whether or not to keep trying to automatically profile him/her.

Once all the information (direct or inferred) is collected from the user, the profile for the user is set in step 814 and stored in step 816. Thus, by asking questions of the user, the system can reach the state where its user profiles are substantially more reliable and complete than those that can be generated purely by inference. At the same time, by partly using inference, the system is able to generate user profiles far more efficiently, and in a more user-friendly way, than by only asking numerous (tedious) questions of the user. The user may be especially encouraged to provide more personal information if the system appears to know something about the user, as determined from its observations. For example, during step 812 the dialog to the user could be: “You really like to channel surf, don't you?”; “Can you tell me your name?”; “Nice to meet you, Chuck!”; “How old are you?” . . . (further dialog designed to elicit demographics).

Some typical profiles generated by the system using information collected during the monitoring of user behavior may look as follows:

| Characteristic | “User 1” | “User 2” | “User n” |
|---|---|---|---|
| Keystroke | 20 | 80 | 50 |
| Speed | | | |
| Keystroke | 80 | 50 | 20 |
| Pressure | | | |
| Errors/minute | 50 | 20 | 80 |
| Viewing | MWF 9-10 PM | TTh 8-9 PM | SS 2-4 PM |
| Time(s) | | | |
| Program | Crime; | Arts | Sports |
| Genres | Reality | | |
| (Wireless Tag | (1) | (2) | (3) |
| #) | | | |

These inferred user profiles are built up over time. For example, a candidate profile for “User 1” may first be populated with only a viewing time (such as M 9-10 PM) and keystroke speed (such as 20) entries. Or it might first be populated with only a viewing time and genre entries. If the PVR later detects viewing at T 8-9 PM, but the keystroke speed is 80, then the PVR can create a candidate profile for “User 2”. This process continues in this manner until the system is relatively confident that it has identified a set of “users” with distinct characteristics, by observing that the characteristics do not vary significantly over a period of, e.g., several days or weeks. In an alternate embodiment, a plurality of standardized profiles are provided based on average viewer habits of a plurality of average viewers. These profiles are then modified using the process described. Each time a profile is obtained in step 804, the system can check in step 806 how populated the profile is. If it is full profile, then it is used as in step 807. If it still missing information, then the user behavior is monitored in step 808 as discussed above.

It can be particularly helpful if the users are actually tagged, e.g., with wireless tags, so that the system can be relatively certain of who the current user is, except that if multiple wireless tags are detected, then it will be necessary for the PVR to use other characteristics to distinguish individual users. Of course it can also be particularly helpful if users “log in”, but nonetheless, keeping track of subconscious characteristics of users (such as channel surfing patterns), can be helpful in deciding which programs to buffer for those users, even given perfect knowledge of which users are present at given times. In other words, there may be “hidden” user likes/dislikes that can be correlated with viewing behavior.

The information in any user's profile may be expanded to cover other information, as follows, using information that is either obtained directly from the user, or inferred from his/her behavior:

| Characteristic | “User 1” | “User 2” | “User n” |
|---|---|---|---|
| Keystroke | 20 | 80 | 50 |
| Speed | | | |
| Keystroke | 80 | 50 | 20 |
| Pressure | | | |
| Errors/minute | 50 | 20 | 80 |
| Viewing | MWF 9-10 PM | TTh 8-9 PM | SS 2-4 PM |
| Time(s) | | | |
| Program | [symbol] | Arts | Sports |
| Genres | Reality | | |
| (Wireless Tag | (1) | (2) | (3) |
| #) | | | |
| Pseudonym | “Tough | “Opera | “No. 1 Fan” |
| | Girl” | Lover” | |
| Age Range | 18-25 | 50-60 | 25-45 |
| Sex | F | F | M |
| “Race” | H | W | B |

Here, through system-user dialog, the system has concluded that, e.g., “User 1” prefers to be called “Tough Girl”, is between 18-25 years of age (as “deduced” from her responses to innocuous questions like what type of clothes and music she likes), her sex, and her “race” (which is deduced to be Hispanic). Also, she denies liking crime shows, even though the PVR recorded the fact that she did once watch a crime show.

In one embodiment, as part of step 814, the system may use the profile as a means of verifying the current user, for purposes of proactively (predictively) buffering programs that may be of interest. Further, the profile can be refined in this step, not only with regard to obvious factors like keeping it up to date on programs/genres watched, but also further averaging characteristics like surfing behavior, to enable more reliable detection of the current user. The profile can also be further augmented by asking occasional questions of the user that are designed to reveal additional demographic information. The profile can also be updated to reflect changing user interests, through asking questions like: “do you still live in New York?”

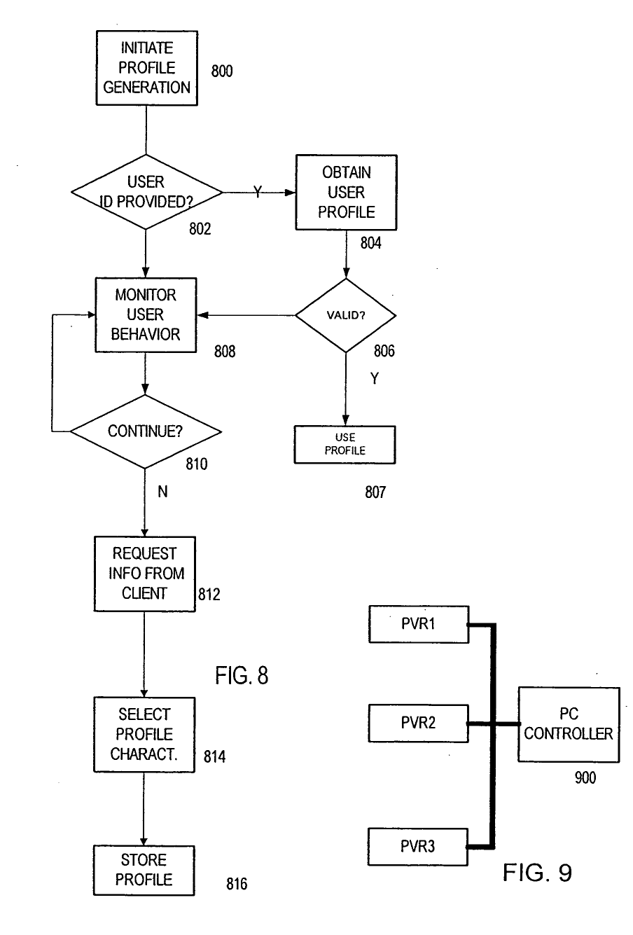

As described above, it is expected that many systems have several users, and moreover, in a given household, the system will include not one, but several PVRs. For example, in the system shown in FIG. 9, a system is provided that includes a central PC controller 900 and several PVRs' e . . . PVR1. PVR 2 and PVR3. The PC controller tracks viewing habits/create profiles for several users on each PVR, according to the above principles. Each PVR records some programs, and the recorded programs are shared on a wired or wireless bus. Several schemes may be provided to allow the PC controller 900 to decide what to record or buffer if there is a conflict (i.e., the number of potential programs that the PVRs “want” to record or buffer to satisfy the viewing desires of all of its potential users exceeds its recording capabilities) To resolve this conflict, the PC controller is provided with a set of rules to select what to record. Analogously to profiling, this setting of recording priorities by the PVR can be accomplished either explicitly or implicitly.

The following represent three scenarios for explicit entry of user priority data:
1. A user assigns buffering priorities at each PVR independently;
2. A user physically assigns priorities at the PC controller. The controller then transmits the priorities to all the PVRs of the system.
3. A user assigns priorities at only one PVR, which is capable of propagating the users profile information to any other desired household PVRs across the network

Unlike the case of entering profile data, explicit priority data should preferably be entered for all users by only one user, who we can call the “super user”.

Recording priority can be implicitly (by the PVRs and not the users) assigned, for example: to the most frequent user of a given timeslot; in round-robin fashion; in a “fair” way, such as by which user got the least recording time to date; previous use or lack of use of the predictive buffering capability by a given user (priority given to user(s) who have a history of actually viewing the predictively-buffered programming), etc.

Hybrid explicit-implicit priority schemes can also be used. For example, the super user can reserve amounts of recording time for him(her)self or any number of other users, while still allowing the remainder of the remaining time/capacity to be allocated in one or more of the “implicit” ways mentioned above. For example, in a PVR with simultaneous multiple channel recording capability, the super user can reserve one recording channel for himself, while leaving any other channels available for implicit priority determination.

Additionally, in a household with multiple PVRs and users three cases can be distinguished:
1. The user has to separately physically register at each PVR (for example, when sitting in front of the TV set attached to the PVR output)
2. The user has to physically register at the PC controller, and his profile is then propagated across a home network to as many household PVRs as desired.
3. The user registers with only one PVR, which is capable of propagating the users profile information to any other desired household PVRs across a home network

While the main purpose of the user profile is to help direct the recording of the predictive buffer, the information can serve other purposes as well such as supporting targeted or “narrowcast” advertising. For the purpose of targeted advertising, it may be desirable for the user to enter personal data such as age, sex, race, income level, hobbies/interests, geographic location, and other information that, while also useful for directing a predictive buffer, may be useful to advertisers who wish to target different demographics.

For user privacy, it is important that such personal information be stored encrypted and under password control; such techniques are well known.

While in the figures, the content being recorded and replayed constitutes multimedia content with audiovisual components, it is further contemplated that invention is used for digital audio recorders (DARs) with automated buffering capability. These types of recorders include both portable (e.g., “car radio” with DAR capability) as well as fixed recorders. For example, in a large metropolitan area, it is not uncommon to want to be able to monitor a number of different radio stations simultaneously. There are often a number of stations that provide regular reports on traffic, weather, sports, etc. However, listening to such stations for extended periods of time becomes tedious as there are numerous commercials and highly-repetitive and/or uninteresting “news” stories in between the actual news. In such cases, it would be desirable to be able to continue to be able to listen to, e.g., the end of a particular musical selection on one channel while simultaneously buffering the audio from e.g., a station that broadcasts regular traffic reports. It is also very possible that one might wish to buffer one or more stations that is (are) broadcasting music while listening to another station in real time. By this means, one can have the capability to play back more or less continuous music (possibly avoiding commercials), and/or replaying more desirable selections that were missed during real-time listening. The above objects are accomplished by radios with predictive buffering capability.

The many features and advantages of the invention are apparent from the detailed specification. Thus, the appended claims are intended to cover all such features and advantages of the invention that fall within the true spirit and scope of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

While the invention has been described in conjunction with a video signal, it is also applicable to the recording of radio programming, or any other broadcast or communicated media stream, including RF or satellite radio signals.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

1. A method for operating a media recorder, the method comprising the steps of:
determining a user profile based on intrinsic information obtained by monitoring user behavior and direct information received from the user; and
buffering or recording at least a portion of a program based on said profile.

2. The method of claim 1 wherein the step of determining said profile is based on a list of channels most recently viewed by the user.

3. The method of claim 1 wherein the step of determining said profile is a predictive process based on a frequency measure of channels watched by a user.

4. The method of claim 1 wherein the step of determining said profile includes an identifying step for identifying the user.

5. The method of claim 4 wherein said step of identifying the user includes monitoring the physical characteristics of data entry by the user.

6. The method of claim 1 wherein the step of determining said profile is a predictive process based on the genre of channels being watched.

7. A method for predictive buffering of programs in a media recorder, the method comprising the steps of:
Recognizing a user based on user behavior;
Associating the user with a profile;
Selecting a signal containing a first set of television programs based on said profile; and
Buffering at least a portion of one program.

8. The method of claim 7 wherein selection of the at least one program from the first set of television programs is based on a predictive process.

9. A system for predictive buffering in a media recorder, the system comprising
a profile selection program adapted to select a profile based on both a user's behavior and direct information provided by the user;
a predictive program selection subsystem, wherein the predictive program selection subsystem selects at least one program determined by the profile; and
a buffering subsystem that buffers a portion of said one program.

10. The system of claim 9, further comprising:
a subsystem that determines the identity of the user.

11. A system for recording programs comprising:
a profile selection program adapted to select a user profile from a plurality of user profiles associated with the system; and
a program selection subsystem that selects at least one program to be recorded at a predetermined time slot, said subsystem selecting the program in accordance with the profile of the user that uses the system most frequently at said preselected time.

12. The system of claim 11 wherein said profile selection program monitors who uses the system and predictively identifies the users.

13. The system of claim 11 wherein said program selection subsystem starts recording the program started during said predetermined time slot and continues recording said program if said program extends into a subsequent time slot independently of what user is identified as being the most frequent user during said subsequent time slot.

14. A system for predictive buffering in a media recorder, the system comprising:
a profile selection program adapted to select a user profile from a set of user profiles, wherein each user profile is determined from viewing habits of the user;
a predictive program selection subsystem, wherein the predictive program selection subsystem selects at least one program determined by the profile; and
a buffering subsystem that buffers a portion of said one program;
wherein said users are prioritized in an order determined by how often a particular user watches buffered program portions, and wherein said profile selection program selects the profile of the user who watches buffered portions most often.

15. A method for operating a radio recorder that records radio from the Internet, a satellite, and the like, the method comprising the steps of:
determining a user profile based on intrinsic information obtained by monitoring user behavior and direct information received from the user; and
buffering or recording at least a portion of a radio program based on said profile.
